(19) United States
(12) Patent Application Publication
(10) Pub. No.: US 2007/0092399 A1
(43) Pub. Date: Apr. 26, 2007

(54) Fluid Examination Chip and Method of Manufacturing the Fluid Examination Chip

(75) Inventor: Kuninori YOKOMINE, Kirishima-shi, Kagoshima (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 11/552,478

(22) Filed: Oct. 24, 2006

(30) Foreign Application Priority Data
Oct. 24, 2005 (JP) P2005-308318
Oct. 27, 2005 (JP) P2005-312318

(51) Int. Cl. G01N 21/00

(52) U.S. Cl. 422/57

(57) ABSTRACT

There is provided a a fluid examination chip includes a channel through which a fluid flows in at least one of a surface and an interior thereof. The channel includes a capture area where a predetermined substance contained in the fluid is caught. Arithmetic average roughness on a surface in at least the part of the capture area of the channel is larger than that on a surface in the other area of the channel.

### BACKGROUND OF THE INVENTION

1. Field of the Invention

The present invention relates to a fluid examination chip that allows highly sensitive detection of substances contained in a fluid that flows thorough a minute channel, and to a method of manufacturing the fluid examination chip.

2. Description of the Related Art

In recent years research and development have been conducted for a fluid examination chip having a channel for allowing circulation of a fluid in a surface of a semiconductor substrate such as a silicone wafer or an insulating substrate made of glass, resin or the like material, and doing various functions for a fluid such as conveyance, detection, measurement and initiation of reactions.

For example, there is known a fluid examination chip composed of a glass substrate on which is formed a channel having a detection area located in a certain part thereof and arranged fluid conveying means such as a micro-pump at one end of the channel. In this fluid examination chip, a fluid is circulated through the channel, and a substance to be detected (hereinafter referred to simply as “target substance”) such as protein contained in the fluid is detected in the detection area by exploiting reflected light with optical detecting means.

Such a fluid examination chip is typically provided with a lid body so that human body is prevented from directly contacting with the fluid flowing through the channel. The lid body acts as a leak-tight seal for the fluid flowing through the channel.

In the above-mentioned fluid examination chip, the lid body is generally made of a translucent material such as glass and transparent resin to allow optical detection by means of fluorescence microscopy or otherwise. That is, when the channel is irradiated with light of certain wavelength such as visible light and ultraviolet light through the lid body, a target substance colored with a fluorescent colorant contained in the fluid emits light of certain wavelength. The presence or absence of the target substance is detected by observation of the resultant fluorescent color.

On the other hand, in accompaniment with recent technological advancement, applications of fluid examination chips in the medical filed have been sought after. This trend has created an increasing demand for a fluid examination chip capable of carrying out highly precise measurement with use of only a trace amount of a fluid. The smaller is the amount of a fluid such as blood, the lighter is a burden imposed upon a patient who provides the fluid. As a natural consequence whereof the need has been intensifying for a fluid examination chip to achieve detection of a target substance such as DNA, protein and an influenza virus, particularly confirmation of the presence or absence of the target substance which exists in very small concentrations, with use of a smaller-than ever amount of a fluid. Thus, it is effective to catch and accumulate a target, substance at the detection area of the channel provided in the fluid examination chip.

For example, in a known document “Introduction to Micro nanomachine technology” (Kogyo Chosakai Publishing Co., Ltd., Aug. 15, 2003, pp. 117-121) is proposed a techniques for creating a mesh-shaped filter in the channel by performing fine patterning on a member made of such as a silicone used for constituting the base body. In this case, a target substance can be caught and accumulated in the mesh-shaped filter.

However, in using the filter, most part of the target substance is accumulated with hidden behind the filter. Thus, even if the channel is irradiated with light of certain wavelength through a translucent lid body, precise detection of the target substance was difficult.

As another problem, as the target substance are accumulated inthe filter one after another, the fluid is increased in circulation resistance. This causes a lack of stability in the flow rate of the fluid. In this case, control of the amount of fluid supply cannot be exercised readily, and fluid conveying means such as a pump is put under load. This makes it difficult to continue necessary operations and analysis with stability. In addition to that, it is needed to form the mesh-like filter with fine patterning and to disposed it in the channel, which leads to poor productivity and high cost of manufacturing.

### SUMMARY OF THE INVENTION

In view of the above-described problems in the related art, the invention has an object is to provide a fluid examination chip that allows detection of a target substance contained in a fluid flowing through a channel with high sensitivity, even if the content of the target substance is extremely low.

To an aspect of the invention, a fluid examination chip includes a channel through which a fluid flows in at least one of a surface and an interior thereof. The channel includes a capture area where a predetermined substance contained in the fluid is caught. Arithmetic average roughness on a surface in at least the part of the capture area of the channel is larger than that on a surface in the other area of the channel.

An advantage of the fluid examination chip of the invention is that it allows the predetermined substance contained in the fluid to be adhered to the surface in at least the part of the capture area having a larger arithmetic average roughness, and thereby facilitate caught of the predetermined substance in the capture area. As a result, the fluid examination chip allows detection of a target substance contained in a fluid flowing through a channel with high sensitivity, even if the content of the target substance is extremely low.

In another aspect of the invention, a fluid detection optical system includes a fluid examination chip, a irradiator and a light receiver. The fluid examination chip includes a base body having a channel through which a fluid flows in at least one of a surface and an interior thereof. The channel includes a capture area where a predetermined substance contained in the fluid is caught. Arithmetic average roughness on a surface in at least the part of the capture area of the channel is larger than that on a surface in the other area of the channel. The irradiator irradiates the capture area with light. The light receiver receives light emitted from the predetermined substance caught in the capture area when being irradiated with light by the irradiator.

An advantage of the fluid detection optical system of the invention is that it allows to do the caught of the predetermined substance contained in the fluid and the detection of the predetermined substance at the same time, with one system.

In another aspect of the invention, a fluid detection electrical system includes a fluid examination chip and a detector. The fluid examination chip includes a base body having a channel through which a fluid flows in at least one of a surface and an interior thereof. The channel includes a capture area where a predetermined substance contained in the fluid is caught and a pair of electrodes arranged in the capture are. Arithmetic average roughness on a surface in at least the part of the capture area of the channel is larger than that on a surface in the other area of the channel. The detector detects the presence of the predetermined substance based on the voltage or current between the pair of electrodes.

An advantage of the fluid detection electrical system of the invention is that it allows to do the caught of the predetermined substance contained in the fluid and the detection of the predetermined substance at the same time, with one system.

In another aspect of the invention, a method of manufacturing a fluid examination chip includes forming a groove in at least one of a plurality of ceramic green sheets, applying glass paste to a part of a surface of the groove, stacking the plurality of ceramic green sheets on top of one another, and firing the plurality of stacked ceramic green sheets. The groove eventually serves as a channel after firing. The glass paste has a softening point lower than a temperature at which the plurality of ceramic green sheet is fired.

An advantage of the method of manufacturing a fluid examination chip of the invention is that it allows to readily manufacture a fluid examination chip that allows detection of a target substance contained in a fluid flowing through a channel with high sensitivity, even if the constant of the target substance is extremely low.

In another aspect of the invention, a method of detecting a predetermined substance contained in a fluid includes preparing a fluid examination chip, irradiating the fluid examination chip with light, receiving a fluorescence emitted from the predetermined substance when being irradiated with light, and analyzing the received fluorescence to detect the predetermined substance. The fluid examination chip includes a base body having a channel through which a fluid flows in at least one of a surface and an interior thereof. The channel includes a capture area where a predetermined substance contained in the fluid is caught. Arithmetic average roughness on a surface in at least the part of the capture area of the channel is larger than that on a surface in the other area of the channel. In being irradiated with light, the captured area is irradiated with light.

In another aspect of the invention, a method of detecting a predetermined substance contained in a fluid includes preparing a fluid examination chip and detecting the predetermined substance caught in the fluid examination chip. The fluid examination chip includes a base body having a channel through which a fluid flows in at least one of a surface and an interior thereof. The channel includes a capture area where a predetermined substance contained in the fluid is caught and a pair of electrodes arranged in the capture area. Arithmetic average roughness on a surface in at least the part of the capture area of the channel is larger than that on a surface in the other area of the channel. The predetermined substance caught in the captured area is detected based on voltage or current between the pair of electrodes.

An advantage of the method of detecting a predetermined substance contained in a fluid according to the invention, is that it allows easy and precious detection of the predetermined substance contained in the fluid.

### BRIEF DESCRIPTION OF THE DRAWINGS

Other and further objects, features, and advantages of the invention will be more explicit from the following detailed description taken with reference to the drawings wherein:

FIG. 1A is a plan view of an example of a fluid examination chip according to a first embodiment of the invention;

FIG. 1B is a sectional view of the fluid examination chip taken along the line I-I of FIG. 1A;

FIG. 2 is a schematic view of an example of a fluid detection optical system according to the invention;

FIG. 3 is a plan view of an example of a fluid detection electrical system according to the invention;

FIG. 4A is a plan view of an example of a fluid examination chip according to a second embodiment of the invention; and

FIG. 4B is a sectional view of the fluid examination chip taken along the line II-II of FIG. 4A.

### DETAILED DESCRIPTION OF THE PREFERRED EMBODIMENT

The following is a detailed description of main embodiments of the invention, with reference to the drawings in which the same numerical references designate the corresponding elements through the different drawings.

### First Embodiment

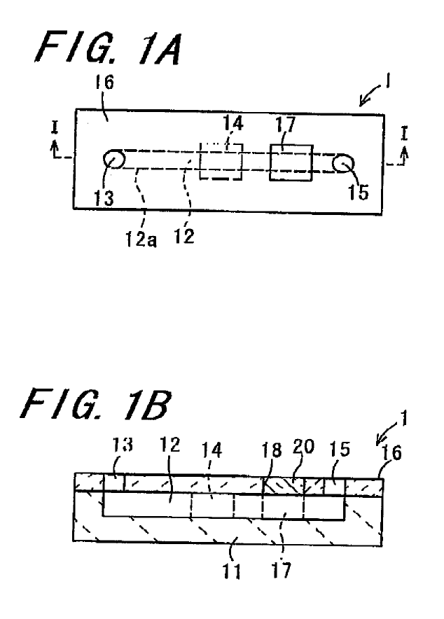

FIG. 1A is a plan view showing an example of the basic constitution of a fluid examination chip 1 according to a first embodiment of the invention. FIG. 1B is a sectional view of the fluid examination chip 1 taken along the line I-I of FIG. 1A.

As shown in FIGS. 1A and 1B, the fluid examination chip 1 is constructed by forming in a base body 11 made of ceramic or the like material, a channel 12 for allowing circulation of a fluid, a supply portion 13 for admitting the fluid into the channel 12, a treatment portion 14 for treating the fluid in a predetermined manner such as chemical reaction, and a discharge portion 15 for letting the fluid out following the completion of examination. Moreover, a part of the channel 12 has a capture area 17 for capturing a target substance contained in the fluid. The capture area 17 is provided in the downstream side of the treatment portion 14 and the upstream side of the discharge portion 15 in a direction along which the fluid flows.

Moreover, a lid body 16 is attached onto the channel 12-present surface of the base body 11 so as to cover the channel 12. This allows circulation of the fluid without the risk of leakage. The lid body 16 is provided with an opening portion 18 for allowing visual examination, examination under a microscope, and optical examination such as spectroscopic analysis.

For example, the base body 11 and the lid body 16 are each made of a ceramic material. The specific examples of the ceramic material used to form the base body 11 and the lid body 16 include sintered aluminum oxide (alumina ceramic), sintered mullite (mullite ceramic), and sintered glass ceramic. Among them, the use of sintered aluminum oxide is more desirable from the standpoint of resistance to heat and chemical attack.

In order to form the base body 11 and the lid body 16 with use of sintered aluminum oxide, at first, an organic solvent and a binder are admixed in a powdery raw material made of aluminum oxide, silicon oxide, calcium oxide and so on. Then, the admixture is shaped into a plurality of ceramic green sheets. Next, the ceramic green sheets are each contoured and sized as desired, and, if needed, they are stacked on top of one another. The process is finished off by performing firing thereon.

For example, the channel 12 is prepared by forming a groove in the ceramic green sheets which are formed into the base body 11, in desired depth and pattern set, by means of impressing, laser-light grinding or otherwise, and by firing these ceramic green sheets in which the groove is formed.

The supply portion 13 is, for example, an opening formed in the lid body 16 at a position facing one end of the channel 12, so that the fluid is supplied through the opening into the channel 12 form the outside of the fluid examination chip 1.

For example, the fluid is directed into the supply portion 13 under pressure by means of the fluid conveying means (not shown) such as a micro syringe, a pump, or otherwise.

The treatment portion 14 is provided for effecting predetermined treatment for the fluid, such as cell dissolution, cell separation, and cell refining through a chemical reaction, heating, electrophoresis, or otherwise. This treatment can result in the extraction of nucleic acid and protein contained in the fluid.

In the treatment portion 14, an extra mechanism required to carry out the aforementioned treatment, such as a heater for application of heat, may be disposed inthe corresponding part of the interior of the base body 11 near the channel 12.

In the treatment portion 14, the channel 12 is not limited to the linear configuration illustrated inthe figure, but may be of another configuration such as serpentine or winding configuration in order to secure a channel path which is long enough for the treatment to be achieved effectively.

The discharge portion 15 is provided to discharge the fluid out of the fluid examination chip 1 after the completion of capture of the predetermined substance by the capture area 17.

The discharge portion 15 is prepared by forming an opening in the lid body 16 through which the fluid is discharged from the channel 12 to the outside.

For example, the opening portion 18 of the lid body 16 is formed by performing stamping such as mechanical punching on the lid body 16 or the unfired ceramic green sheets which are formed into the lid body 16. Likewise, the opening of the lid body 16 for constituting the supply portion 13 and the opening of the lid body 16 for constituting the discharge portion 15 each can be formed by performing stamping such as mechanical punching at predetermined locations on the ceramic green sheets which are formed into the lid body 16.

Moreover, the fluid examination chip 1 according to the first embodiment, at least a part of the surface in the capture area 17 of channel 12 has larger arithmetic average roughness than the surface in the other area of the channel 12. This allows the target substance contained in the fluid to be adhered to the surface of target arithmetic average roughness in the capture area 17, and therefore allows the target substance to be readily accumulated smoothly. In this case, at least the part of the surface in the capture area 17 includes at least a bottom surface of the channel 12.

The lid body 16 is provided with the opening portion 18 in a portion opposed to the capture area 17 so that the optical examination can be performed. In this case, the portion opposed to the capture area 17 is a portion which is positioned on the upper side of the capture area 17 in a configuration shown in FIG. 1B and which is an area overlapped with at least the capture area 17 when the fluid examination chip 1 is viewed from a plan view. In the opening portion 18 provided with the lid body 16 is fitted a lid portion 20 made of a translucent material. Note that, as the translucent material for use, silicone resin having translucency and high workability, or the like material is usable.

When the target substance captured by the capture area 17 is detected by the optical examination, the fluid containing the target substance is colored with a fluorescent reagent in the fluid examination chip 1, before or after the fluid is supplied to the fluid examination chip 1. At this time, a kind of the fluorescent reagent and other conditions are selected so as not to color impurities or the like other than the target substance. Thus the fluorescence can be observed only in the case where the target substance is contained in the fluid when irradiated with light of certain wavelength.

In the fluid examination chip 1, the fluid introduced into the channel 12 from the supply portion 13 is subjected to a predetermined treatment at the treatment portion 14, and then the target substance is captured at the capture area 17. Following the completion of the capture of the target substance, the fluid is discharged to the outside through the discharge portion 15. For example, in a case where a reagent is temporarily set in the treatment portion 14, upon the fluid containing a biological substance such as protein or DNA being supplied through the supply portion 13, the biological substance and the reagent react with each other at the treatment portion 14. Accordingly, capture of the resultant biological substance in the capture area 17 allows microscopical detection of the biological substance through the translucent lid portion 20 made of the translucent material. At this time, there is no risk of direct contact of human body with the biological product. Subsequently, the biological product is swiftly discharged through the discharge portion 15.

Specifically, at the instant when the fluid reaches the capture area 17, the target substance contained therein is caught in the surface of the channel 12 in the capture area 17. Then, upon the capture area 17 being irradiated with light of certain wavelength such as visible light or ultraviolet light through the lid portion 20 of the lid body 16, the target substance colored with a fluorescent colorant, which is contained in the fluid, emits light of certain wavelength. The presence or absence of the target substance is detected by observation of the fluorescent color, that is, no fluorescent color is observed in the absence of the target substance. When the capture area 17 is observed by using a microscope in addition to the observation of the fluorescence, the target substance can be detected more precisely.

According to the first embodiment of the fluid examination chip 1, it will thus be seen that, even if the concentration of the target substance contained in the fluid is low, since the target substance is caught and accumulated in the surface of the channel 12 corresponding to the capture area 17 successfully, it follows that the presence or absence of the target substance can be detected effectively. As a result, the fluid examination chip 1 will succeed in conducting highly sensitive detection of the target substance.

Moreover, there is no need to provide a filter or the like structure in the capture area 17 by means of fine patterning technique. Therefore, the target substance accumulated in the filter portion one after another will eventually cause no difficulty in control of the amount of fluid supply and no placement of load on fluid supply means such as a pump. Further, capture and accumulation of the target substance contained in the fluid can be achieved simply by giving the surface of the capture area 17 rough finish without the necessity of disposing a mesh-like filter separately formed by means of fine patterning techniques. This leads to high productivity and low cost of manufacturing the fluid examination chip.

As has already been explained, in the fluid examination chip 1, the lid body 16 has its part lying above the capture area 17, that is the lid portion 20, made to exhibit translucency. This allows the target substance accumulated in the capture area 17 to be observed by a visual or microscope examination without dissolving the fluid examination chip 1. In addition, since the lid body 20 has translucency allowing the detection by the optical means, the fluid examination chip 1 will succeed in conducting highly sensitive detection by optical means.

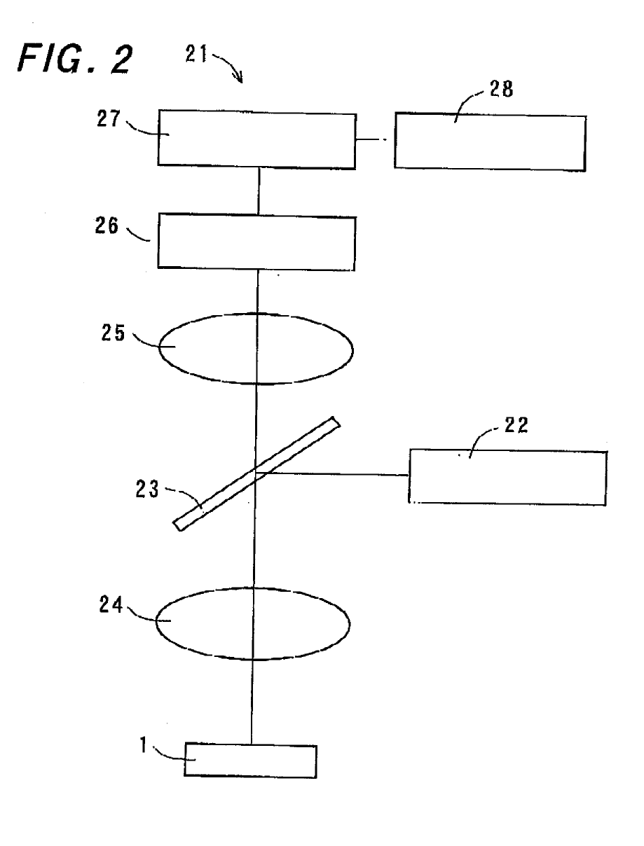

FIG. 2 shows an example of the constitution of an optical system with which the target substance caught in the fluid examination chip is detected using an optical technique. As shown in FIG. 2, a fluid detection optical system 21 includes an excitation light source 22, a dichroic mirror 23, an objective lens 24, an imaging lens 25, an imaging device 26 such as a charge coupled device, an analyzer 27 and display 28.

In this fluid detection optical system 21, the excitation light source 22 outputs flux of light for fluorescence excitation. The dichroic mirror 23 reflects almost all of the light output from the excitation light source 22. Here, the dichroic mirror 23 is configured to be highly reflective to the light of a certain wavelength output from the excitation light source 22. The reflected light enters the fluid examination chip 1 through the objective mirror 24.

The light entering the fluid examination chip 1 reaches the capture are 17 through the lid portion 20 of the lid body 16. The target substance caught in the captured area 17 generates fluorescence. The fluorescence emitted from the target substance enters the dichroic mirror 23 through the objective mirror 24. The wavelength of the fluorescence from the target substance is different from that of the excitation light output from the excitation light source 22.

When the dichroic mirror 23 has low reflectivity and high transmission for the wavelength of the fluorescence from the target substance, all of the fluorescence pass through the dichroic mirror 23. The fluorescence passing through the dichroic mirror 23 is focused on the imaging device 26. The imaging device 26 converts the fluorescence from the target substances to electrical signals. The analyzer 27 analyses the signals sent from the imaging device 26 to measure an optical property 1 of the target substance and sends the result of the measurement to the display 28. The display 28 displays the result of the measurement by the analyzer 27. Accordingly, an observer can detect the target substance caught in the fluid examination chip 1 by observing the result of the measurement displayed in the display 28.

In this fluid detection optical system 21, the excitation light source 22 constitutes an irradiator which irradiates the capture area 17 with light. And the imaging device 25 constitutes a light receiver which receives fluorescence from the target substance in irradiating the capture area 17 with light.

Further, the imaging device 25, analyzer 27, and display 28 may be omitted to configure a fluorescence microscope with which the fluorescence from the target substance can be observed. Further, the analyzer 27 can detect the target substance based the result of analysis and send the result of the detection to the display 28.

In the above example, the fluorescence from the target substance is observed in order to detect the target substance. However, the optical property of the target substance may be measured by analyzing the reflected light and scattered light from the target substance.

It will be described how the channel 12 is designed so that its surface in at least a part of the capture area 17 is larger in arithmetic average roughness than its surface in the other area: for example, at first, the base body 11 is constructed of sintered ceramic which is formed from powdery ceramic particles with a large particle size, while the channel 12, except for the area corresponding to at least a part of the capture area 17, received application of glass in a larger amount. The powdery ceramic particles with a large particle size corresponds to for example the powdery ceramic particles with 1 μm or above in average particle diameter. In this case, the glass elements find their way into the powdery ceramic particles, thereby smoothing out the surface of the channel 12 in the area except for at least a part (hereinafter referred to as a rough surface area) of the capture area 17 of the channel 12. As a result, arithmetic average roughness of the surface of the channel 12 in the rough surface area is larger than that of the surface of channel 12 in the other area.

The specific examples of the glass material for use include quartz glass, silica glass, soda glass, lime glass, borate glass, and lead oxide glass.

Here is how glass is applied in a larger amount to, of the base body 11, the area (hereinafter referred to as smooth surface area) of the channel 12 except for the part corresponding to the rough surface area: for example, in the case of constructing the base body 11 of sintered aluminum oxide, to the channel 12 is applied glass in powder (paste) form whose softening point is lower than the firing temperature of the sintered aluminum oxide. Then, the glass is sintered at a temperature lower than the melting point of sintered aluminum oxide. In this way, the amount of glass present on the surface of the channel 12 in the smooth surface area is increased.

In the meanwhile, by using a glass material whose softening point is close to the firing temperature of the sintered aluminum oxide, it is possible to make the amount of glass present on the smooth surface area of the channel 12 larger than that present on the rough surface area thereof by means of simultaneous sintering.

Note that the channel 12 can be designed such that its surface in the rough surface area is larger in arithmetic average roughness than its surface in the other area, also by the following mechanical surface roughening technique. On a surface of a green sheet formed of an aluminum oxide material by means of doctor blade technique is pressed a die of which surface corresponding to the rough surface area is roughened.

It is preferable that the arithmetic average roughness (designated as “Ra” according to Japanese Industrial Standards (JIS) B 0601-1994) of the surface in the rough surface area of the channel 12 exceeds 1 μm. In the case of setting the surface roughness of the rough surface area to be greater than 1 μm, the roughness of the rough surface area's surface is sufficiently large relatively to the size of the target substance contained in the fluid. This helps to expedite the adhesion and accumulation of the target substance contained in the fluid in the asperities on the surface of the rough surface area, and thereby allow detection with higher sensitivity. As a result, when the roughness of the surface in the rough surface area is greater than 1 μm, the fluid examination chip 1 can be used for the analysis of a biological substance such as protein and DNA, which requires high accuracy in demand for the medical filed.

When the arithmetic average roughness of the rough surface area is greater than 1 μm, the fluid flows turbulently and is thus allowed to remain in the rough surface area. That is, the target substance contained in the fluid is brought into contact with the channel surface fairly frequently. This helps to increase the likelihood of the target substance being caught in the asperities on the channel surface, thereby facilitating the buildup of the target substance in the rough surface area. In other words, it does not occur that the target substance passes through the rough surface area without stopping. It is thus possible for the target substance to be caught and accumulated on the surface of the rough surface area more effectively, and thereby allow reliable detection of the target substance even if its content in the fluid is low.

The length of the rough surface area is determined in a manner so as to ensure that the capture of an adequate amount of the target substance can be achieved with consideration given to the expected size and content (concentration) of the target substance and to the type of detecting means.

It is preferable that the cross-sectional area perpendicular to a flowing direction of the fluid in the channel 12 is adjusted to fall in a range of from 2.5×10⁻³ mm² to 1 mm³ from the standpoint of allowing effective circulation of the fluid admitted into the channel 12 through the supply portion 13. The same hold true for creating the capture area 17. If the cross-sectional area of the channel 12 is 1 mm² or smaller, the adequate amount of the fluid is made to travel therethrough so that the fluid examination chip could bring about the intended effect of greatly reducing the duration of time that is needed to cause a reaction by increasing a reactive surface area per unit of volume. By contrast, if the cross-sectional area of the channel 12 is 2.5×10⁻³ mm² or larger, there reduces a loss of pressure produced by fluid conveying means such as a micro syringe and a pump, resulting in an excellent fluid circulation without problems.

The arithmetic average roughness of the surface of the channel 12 exclusive of the area corresponding to the rough surface area is set preferably at or below 1 μm, more preferably at or below 0.1 μm. If the arithmetic average roughness thereof is greater than 1 μm, the target substance contained in the fluid is liable to adhere to an accumulate on the area exclusive of the rough surface area, for example the area between the supply portion 13 and the capture area 17. This leads to an undesirable decrease in the concentration of the target substance contained in the fluid which flows into the capture area 17, with the result that, quite inconveniently, the amount of the target substance caught and accumulated inthe capture area 17 is too small to achieve detection with high sensitivity.

It is preferable that the capture area 17 has a uniform roughness throughout its surface. That is, it is preferable that the whole area of the capture area 17 is adapted to the rough surface area. If the surface roughness of the capture area 17 has a uniform roughness throughout, its surface, the amount of the target substance contained in the fluid caught and accumulated inthe detection portion 17 stays constants with each fluid circulation. This leads a high detection reproducibility.

It is preferable that the area of the channel 12 exclusive of the area corresponding to the capture area 17 has a uniform roughness through its surface. If the surface roughness thereof has a uniform roughness through its surface, there arises no fluid turbulence or no loss of pressure locally, so that the fluid circulation control is made easier.

It is preferable that the capture area 17 has a quadrilateral cross-sectional profile, when the fluid examination chip 1 is viewed at a cross-section. If the capture area 17 has a quadrilateral cross sectional profile, it becomes easy to attain proper focus during observation under a fluorescence microscope, in a consequence whereof the target substance can be detected with higher sensitivity, in comparison with the case where the bottom surface has a curve.

When the channel 12 is provided on the surface of the base body 11 like the fluid examination chip 1 of the first embodiment, it is preferable that the lid body 16's surface opposed to the rough surface area of the channel 12 has a surface roughness identical to the rough surface area, and it is preferable that the surface opposed to the smooth surface area of the channel 12 has a surface roughness identical to the smooth surface area.

In the fluid examination chip 1 as described hereinabove, the base body 11 is made of a ceramic material, but it can be made of other material such as a resin. When the base body 11 is made of a ceramic material, the channel 12 can be formed in the base body 11 through a simple process such as the aforesaid impressing process without the necessity of performing working such as etching that will be required for forming the channel 12 in a base body made of silicone, glass, or resin. Thus, by using a ceramic material to form the base body 11, it is possible to produce the fluid examination chip 1 of the first embodiment with high productivity at lower manufacturing cost. As another advantage, ceramic materials are higher in chemical resistance, heat resistance, and strength than other materials such as resin. That is, even if the fluid has a corrosive nature such as strong acidity or strong alkalinity, predetermined treatment and examination can be carried out with stability.

Accordingly, the ceramic-made base body 11 can contribute to provision of the fluid examination chip 1 that allows highly precise detection of target substance with excellence in strength, reliability, and practicality.

The fluid examination chip 1 such as shown herein is basically composed of the base body 11 having the channel 12 and the capture area 17 for capturing the target substance. Preferably, just as with the present embodiment, the fluid examination chip 1 is provided with the supply portion 13 for admitting the fluid into the channel 12, the treatment portion 14 disposed partway along the channel 12, for effecting a predetermined treatment, the capture area 17 located downstream from the treatment portion 14, and the discharge portion 15 for letting the fluid out following the completion of the predetermined treatment and examination.

To the fluid examination chip 1 thus constructed, the fluid introduced into the channel 12 from the supply portion 13 is subjected to a predetermined treatment at the treatment portion 14, and is then examined at the capture area 17. Following the capture of a desired substance in the treated fluid, the fluid containing the rest of the substance is discharged to the outside through the discharge portion 15. For example, it is possible to achieve detection of a biological substance such as protein and DNA, and also an environmental toxic substance such as viruses, dioxins, and PCBs. That is, the fluid examination chip 1 affords high practicality for medical and analytical purposes.

Moreover, if the base body 11 is made of ceramic, in addition to the excellence in chemical resistance, heat resistance, and strength, the base body 11 has the advantage of easiness of forming a multilayer structure. This makes it possible to achieve incorporation of a heater, an electrode, an electric circuit, or the like component, as well as to construct a three-dimensional channel structure with ease.

Accordingly, if the base body 11 is made of ceramic, the invention provides the fluid examination chip 1 that is excellent in precision in analysis, strength, reliability, and practicality.

For example, it is possible to impart a winding or serpentine configuration to the treatment portion 14. In this case, the fluid can be heated efficiently at the treatment portion 14 by a heater emplaced therebelow within the base body 11. This helps expedite treatment such as initiation of a chemical reaction.

It is also possible to dispose inside the channel 12 a pair of electrodes (not shown) that is led out to the outer surface of the base body 11 via a wiring conductor (not shown) formed within the base body 11. In this case, a potential can be applied between the two electrodes through the wiring conductor, and thereby the fluid is subjected to a predetermined treatment such as electrophoresis.

For example, the electrode and the wiring conductor are formed by print-coating a metal material in the form of paste such as tungsten, molybdenum, manganese, copper, silver, gold, platinum, or palladium onto the ceramic green sheets which are formed into the base body 11. It is preferable that the electrode is, when designed to be exposed at the surface of the channel 12, plated with a metal layer which exhibits high normal electrode potential such as gold or platinum in consideration of the possibility of the fluid having a corrosive nature.

It is also possible to detect the substance caught in the capture are 17 by disposing on the surface of the channel 12 in the capture area 17 a pair of electrodes that is led out to the outer surface of the base body 11 via a wiring conductor formed within the base body 11, and by detecting the current or voltage between the pair of electrodes. For example, when a certain DNA (hereinafter referred to as complementary DNA) which has complementary base sequence to DNA to be captured (hereinafter referred to as target DNA) is deposited on one of the pair of electrodes in order to detect whether the target DNA is contained in the fluid, if the fluid contain the target DNA, the target DNA and complementary DNA blinds by hybridization reaction. When the two DNAs binds as described above, current occurs between the pair electrodes. Thus, it can be detected whether the target DNA is contained in the fluid by detecting the current flowing between the pair of electrodes.

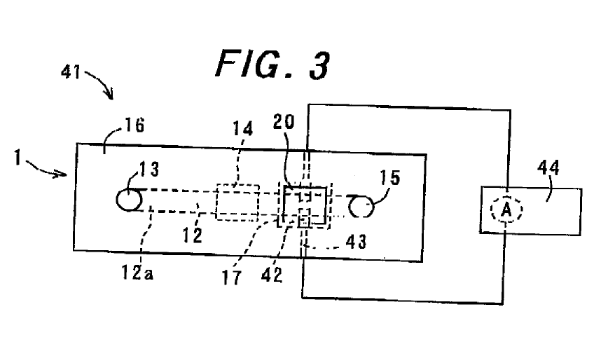

FIG. 3 is a plan view of an example of a fluid detection electrical system including the fluid examination chip which can detect DNA. As shown in FIG. 3, a pair of electrodes 42 is disposed on the surface of the channel 12 in the capture area 17. The pair of electrodes 42 is led out to the outer surface of the base body 11 via a wiring conductor 43 formed within the base body 11. And the complementary DNA, which has complementary base sequence to the target DNA, is deposited on one of the pair of electrodes 42. An electrical detector 43 detects whether the target DNA is adhered to the other of the pair of electrodes 42 by measuring current flowing between the pair of electrodes 42.

The channel 21 may be formed inthe surface of the base body 11 and may be formed in the interior of the base body 11. If the channel 21 is formed in the surface of the base body 11, it is possible to readily detect the target substance caught by the capture area 17. Further, if the lid body 20 is translucent, it is also possible to easily observe how the fluid is treated in the treatment portion 14, whether the target substance is caught in the capture area 17 or not, the amount of the substance, and so on. While, if the channel 21 is formed in the interior of the base body 11, the fluid is not affected optically by the external environment of the fluid examination chip 1. Thus the reaction conducted in the fluid examination chip 1 is not affected by the external environment.

In addition, a plurality of the channels may be formed in the surface of the base body 11, and may be merged together at some midpoint on the surface. This makes it possible to deal with a plurality of different fluids at a time or to effect such a treatment as synthetic reaction. Moreover, the channel 12 may be configured with a plurality of upper and lower branch ducts (not shown) which are connected between the supply portion 13 and the discharge portion 15, and the plurality of branch ducts may be connected with at least one vertical duct (not shown) which extends in the thickness-wise direction in the interior of the base body 11. By constituting the channel 12 in the form of the plurality of upper and lower branch ducts and the vertical duct, it is possible to attain a higher degree of flexibility in channel pattern configuration. For example, in the case of providing a plurality of channels 12 of which each have the treatment portion 14, a plurality of fluids can be treated and examined at one time. As a result, reactions and analysis can be effected efficiently in a shorter while. Moreover, the base body 11 may be provided with the plurality of supply portions 13 and the plurality of discharge portions 15, and the channel 12 may be provided between each of the supply portions 13 and each of the corresponding discharge portions 15.

In the case of providing the capture area 17 also in the channel 12 formed in the interior of the base body 11, an opening is formed from the surface of the base body 11 to the capture area 17 by mechanical grinding means, for example. This makes it possible to carry out observation of the capture area 17 from above. Moreover, the surface of the capture area 17 may be disposed opposed to the surface of the base body 11.

The branch duct or vertical duct as described above can be formed by performing mechanical punching or working such as that which is adopted to create the channel 12 on the sheet corresponding to an inner layer during sheet lamination, of the ceramic green sheets which are formed in to the base body 11.

Note that the fluid is poured in to the fluid examination chip 1 through the supply portion 13 by means of a micro-syringe or otherwise. In this case, the fluid can be conveyed from the supply portion 13 to the discharge portion 15 smoothly. Alternatively, conveyance of the fluid can be achieved by applying a pressure to the fluid at the time of injection with use of a pump or the like disposed externally of the fluid examination chip 1. In another alternative, conveyance of the fluid can also be achieved under suction effected at the discharge portion 15 by means of a mirco syringe or otherwise at the time of supplying the fluid through the supply portion 13.

Note also that the lid body 16 may be composed of the translucent material as a whole. In the case of using a silicone rubber-base material such as polydimethylsiloxane (PDMS), it is possible to impart tackiness to the silicone rubber surface under certain heat-treatment conditions by changing the degree of cross-linking according to the amount of application of a curing agent. This helps facilitate attachment and detachment of the lid body 16 to and from the ceramic-made base body 11, wherefore a cleaning process after using is no trouble at all. Since reuse is permitted in this case, the use of a silicone rubber-base material is advantageous in terms of practicality and cost.

### EXAMPLE

Now, a description will be given below as to actual implementation examples of the fluid examination chip according to the first embodiment. Fluid examination chip samples used for evaluation were formed as follows. At first a slurry is prepared with use of an aluminum oxide raw material at a viscosity of 2 Pa.s. The slurry is then shaped into green sheets by means of doctor blade technique. Next, a plurality of dies are, at their differently roughened surfaces, pressed against respective ones of the green sheets in a location on the surface corresponding to the capture area under a pressure of 5 MPa, so that a linear channel may be obtained that is 100 μm in width, 100 μm in depth, 5 cm in length, and 5 mm in capture-area length. Here, in the linear channel, the capture area has a width of 5 mm, and the other area of the channel has a width of 100 μm. After that, the green sheets are fired at a temperature of approximately 1600° C. Following the completion of the firing there are obtained six pieces of 40 mm-width, 70 mm length, 1 mm thick ceramic base body samples of varying arithmetic average surface roughness of the capture area, 0.9 μm, 1.0 μm, 1.1 μm, 1.2 μm, 1.3 μm, and 1.4 μm. In the above description, the length means the length along the direction in which the fluid flows, the width means the length in the direction perpendicular to the direction in which the fluid flows with viewed at a top view.

The arithmetic average roughness of the bottom surface of the channel in the capture area was measured by means of a surface roughness measuring instrument (product name: SE-2300 manufactured by Kosaka Laboratory Ltd.) according to JIS B 0601-1994 under conditions of a cutoff value of 0.8 mm and an evaluation value of 4 mm.

The lid body which is formed by laminating a 0.25 mm-thick glass as a laminating material on a 0.25 mm-thick silicone resin, is bonded to each of the base bodies. The lid body is provided with through holes of diameter of 2 mm, each of which constitutes the supply portion and the discharge portion communicating with the channel of the base body. This through holes communicate with the capture area of 5 mm in the length and of 5 mm in the width, formed in the base body.

The silicone resin material is made of polydimethylsiloxane, the hardness and the tackiness of which are set at 6 and 5, respectively, by changing the degree of cross-linking according to the amount of application of a curing agent under certain heat-treatment conditions.

The hardness of the silicone resin material was measured by means of a hardness test apparatus (product name: Durometer Type ESC) manufactured by Elastron, Inc in accordance with the standard of the Japanese Society of Rubber Industry SRIS 0101 (based on a spring type hardness instrument Asker C model). The hardness measurement was conducted immediately after the intimate contact of the surface of the material to be pressurized. On the other hand, the tackiness thereof was measured by means of a tackiness test apparatus (product name: Tackiness tester LST-57) manufactured by Bansei corporation in accordance with Rolling Ball Tack Teck (according to JIS Z 0237) at a tilting angle of 30 degrees.

The samples for evaluation thus constructed were subjected to measurement of the buildup of target substance on an individual basis as follows. At first a protein solution is prepared by using a solution of protein (10 mg/mL) (A9771: manufactured by SIGMA-ALDRICH Corporation) and a TE buffer solution (reagent specially made for molecular biological research) having a pH of 8.0. The protein solution is poured into the sample through the supply portion by means of a micro-syringe at a flow rate of 0.1 cm³/min. and then circulated through the channel for three minutes. After that, the bottom surface of the channel was observed within a given area: 100 μm in length and 100 μm in width through the opening of the detection portion under a fluorescence microscope of 100 magnifications. The results of the observation are listed in Table 1.

In Table 1, “Good” entered in the accumulation section represents that capture and accumulation of protein on the bottom surface of the channel is kept at the level of 100% per observation area, whereas “Poor” represents that capture and accumulation of protein on the bottom surface of the channel is not at the proper level, which results in the exposure of the ceramic constituting the base body.

TABLE 1

| | Ra (μm) | | | | | |
|---|---|---|---|---|---|---|
| | 0.9 | 1.0 | 1.1 | 1.2 | 1.3 | 1.4 |
| Accumulation | Poor | Poor | Good | Good | Good | Good |

As will be understood from Table 1, the sample for evaluation having an arithmetic average surface roughness of greater than 1 μm is able to concentrate the protein solution in the capture area through the effective capture of protein.

In addition, in part of the channel may be disposed, as fluid conveying means, a micro-pump such as an actuator-type micro-pump or a pump of electrical osmotic type.

Moreover, the lid body 16 may be composed of part of the base body 11, that is, the lid body 16 may be formed integrally with the base body 11. Further, although the above description deals with the case where that part of the lid body 16 which lies above the capture area 17 is made to exhibit translucency, it is possible to impart translucency to that part of the chip body which is located below or parallel to the capture area 17 in the base body 11. Also in this case, the detection of target substance can be achieved successfully. Note that, in the case of imparting translucency to that part of the chip body which is located parallel to the capture area 17 in the base body 11, smooth and rough surface areas may be provided on the side of the channel 12.

Moreover, in the above description, the case is cited where the target substance captured by the capture area 17 is detected by the optical examination. The rough surface area is formed in at least a part of the inner surface of the channel 12, and the predetermined substance is captured by the rough surface area, and then the fluid examination chip 1 is dissolved to examine the captured substance.

Meanwhile, in the description above, the case is cited where the fluid examination chip 1 is utilized for detection of an environmental toxic substance such as dioxins and PCBs. However, applicable fields are not limited to those stated above, and the fluid examination chip 1 can be utilized in a wide range of filed such as chemical technology and biotechnology. For example, the following uses are also applicable: that is, reaction for forming double-stranded structure of test DNA and known DNA, namely hybridization is performed by the treatment portion 14, and then the reaction result is detected by the capture area 17. Subsequently, the use of the fluid examination chip 1 can increase a reaction surface area per unit volume of a sample, and considerably reduce a reaction time period, because an apparatus and a structure are miniaturized in comparison with a conventional laboratory-scale chemical system such as a so-called beaker size. And precise control of a flow amount allows reaction and analysis to be effective, then causing an amount of a sample and a reagent necessary for reaction and analysis to be reduced.

### Second Embodiment

Next, a fluid examination chip according to a second embodiment of the invention will be described. The fluid examination chip according to the second embodiment of the invention differs from the fluid examination chip according to the first embodiment of the invention in that the surface of the channel 12 except for the area corresponding to the rough surface area is coated with a material whose contact angle with a fluid is smaller than that of a material constituting a base body 11.

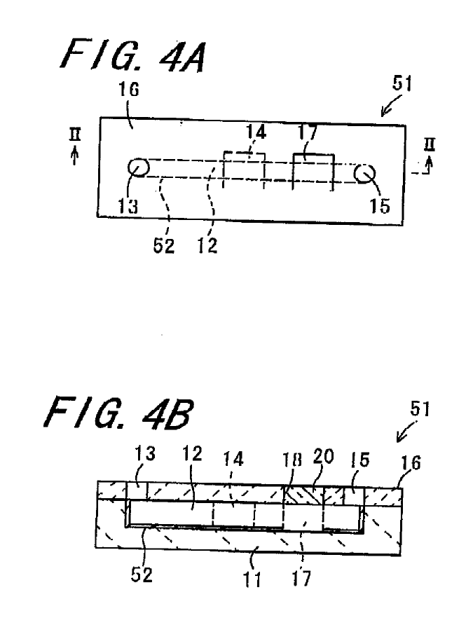

FIG. 4A is a plan view showing an example of the basic constitution of a fluid examination chip 51 according to the second embodiment of the invention. FIG. 4B is a sectional view of the fluid examination chip 51 taken along the line II-II of FIG. 4A. Note that constituents shown in FIGS. 4A and 4B, which are the same as those of the micro-sized chemical chip 1 shown in FIGS. 1A and 1B will be denoted by the same numerals, and descriptions thereof will be omitted. In the fluid examination chip 51 shown in FIGS. 4A and 4B, the surface of the channel 12 except for the area corresponding to the capture area 17 is coated with a material 52 (hereinafter referred to as a coating material 52) whose contact angle with a fluid is smaller than that of a material constituting a base body 11. In this case, the whole area of the capture area 17 is adapted to the rough surface area.

As described above, when the area of the channel 12 except for the area corresponding to the rough surface area, that is, the surface area of the smooth surface area is coated with the coating material 52, the fluid is readily wet with the surface of the smooth surface area of the channel 12 and thus flow therethrough smoothly, during which it does not occur that constituents of the fluid are adhered or adsorbed to the channel 12. Therefore, it does not occur that the target substance is captured by the surface of the smooth surface area to thereby prevent the target substance from being detected in the rough surface area, thus providing reaction and analysis with higher accuracy for the fluid flowing in the channel.

Moreover, the smooth surface area may have its surface covered with a coating material 52 which is such that a contact angle between the coating material and water is smaller than a contact angle between the material constituting the base body 11 and the fluid. In general, the fluid constraining a biological substance such as protein or DNA takes the form of aqueous solution. Therefore, the smaller is a contact angle with water, the more likely it is that the fluid is readily wet with the channel surface and thus flows therethrough smoothly. Accordingly, by obtaining as small a contact angle with water as possible, it is possible to prevent adhesion and adsorption of the constituents of the fluid to the channel 12, and thereby effect reactions and analysis with high accuracy.

It is preferable that the coating material 52 is designed to exhibit a contact angle with water of 40° or below when measured by sessile drop method under conditions of a temperature of 24° C. and a humidity of 53% RH. On the other hand, the base body 11, when made of a ceramic material such as sintered aluminum oxide, has a contact angle with water of approximately 55°.

To be more specific, when a droplet of the fluid is placed on a surface of a solid material constituting the base body 11 or the coating material 52, a contact angle with the fluid or water is defined by the angle which a tangent to the surface of the droplet at a point of contact between the solid material and the droplet makes with the surface of the solid material.

For example, contact angles are measured in accordance with sessile drop method by means of a contact angle meter type CA-X manufactured by Kyowa Interface Science Co., Ltd. For comparison purposes, all the measurements are conducted under the same conditions relating to temperature, humidity, the amount of the fluid droplets, the cross-sectional area of the channel 12, the arithmetic average roughness of the channel surface, and other factors influential with measurement results.

As described hereinabove, in the fluid examination chip 51 according to the second embodiment, the smooth area of the channel 12 formed in the base body 11 has its surface covered with the coating material 52 which is such that its contact angle with the fluid or water is smaller than a contact angle between the base body 11 and the fluid or water. Therefore, the fluid is readily wet with the surface of the smooth surface area of the channel 12 and thus flows therethrough smoothly, during which it does not occur that the constituents of the fluid are adhered or adsorbed to the surface of the smooth surface area of the channel 12. This makes it possible to effect reactions and analysis with high accuracy. Consequently, even if a biological substance or the like contained in the fluid, with relatively high hydrophobic property attempts to be adhered or absorbed to the surface of the channel, the fluid as those media can wet and expand on the surface of the channel to wash away the biological substance or the like.

In the case where the fluid containing a biological substance such as protein or DNA takes the form of aqueous solution, the smaller a contact angle with water is, the more likely it is that the fluid is readily wet with the channel surface and thus flows therethrough smoothly. Accordingly, it is possible to prevent the constituents of the fluid from being adhered or absorbed to the channel, and thereby effect reactions and analysis with high accuracy.

In the fluid examination chip 51 of the second embodiment, the surface of the base body 11 is provided with a supply portion 13 for admitting the fluid onto the channel 12, a treatment portion 14 disposed partway along the channel 12, for effecting a treatment, a capture area 17 located downstream of the treatment portion 14, and a discharge portion 15 for discharging the fluid out following the completion of treatment. Therefore, when the fluid is supplied from the supply portion 13 to the channel 12, the supplied fluid is subjected to the predetermined treatment in the treatment portion 14, the predetermined substance in the treated fluid is captured in the capture area 17, then discharging the fluid containing the remaining substance to the outside at the discharge portion 15. Therefore, for example, this allows measurement of the level of blood sugar in the blood, hybridization of duplex DNA structure, namely double-stranded structure of test DNA and known DNA, and detection of an environmental toxic substance such as dioxins and PCBs. That is, the fluid examination chip 1 affords high practicality for medical and analytical purposes.

Note that the surface of the smooth surface area of the channel 12 includes at least the bottom surface and the side surface thereof formed in the base body 11. In the case where the surface of the lid body 16 opposed to the smooth surface of the channel 12 is also covered with the coating material 52, all the inner surfaces surrounding the channel 12 contacted by the fluid are small in angle at which the surface is wet with the fluid. This makes it possible to prevent the adhesion and adsorption of the target substance more effectively, and thereby effect reactions and analysis with higher accuracy than ever.

The specific examples of the material that is smaller in contact angle with the fluid or water than the base body 11 made of a ceramic material include glass-base materials such as quartz glass, silica glass, soda glass, lime glass, borate glass, and lead oxide glass, and resin-base materials such as fluoride resin having a hydrophilic functional group, silicone rubber having a hydrophilic functional group such as polydimethyl siloxane (PDMS), and polyethylene terephthalate having a hydrophilic functional group.

For example, the coating material is formed as follows. At first a glass paste is prepared by kneading powdery quartz glass with suitable organic solvent and binder. Then, the glass paste is applied to the ceramic green sheets which are formed into the base body 11 by means of print coating technique at the corresponding position of the groove acting as the channel 12.

It is preferable that the coating material 52 has an electrical insulation property with consideration given to arrangement of a pair of electrodes in the inner surface of the channel 12 for the purpose of occurrence of separation through electrophoresis and potential measurement or the like of the fluid.

Moreover, in the case of composing the base body 11 of a ceramic material, the coating material 52 should preferably range in thickness from 1 to 10 μm. If the thickness is 1 μm or more, there is a possibility that asperities on the channel surface of the ceramic-made base body can be reduced sufficiently. By contrast, if the thickness is 10 μm or less, it becomes easy to exercise thickness control properly.

It is preferable that the coating material 52 for covering the channel 12 is made of a glass material. Glass is an amorphous substance in a supercooled fluid state. Because of its high degree of surface smoothness, application of a coating of the glass-made coating material 12a to the channel 12 contributes to reduced contact angle. Therefore, the fluid is readily wet with the channel surface and thus flows therethrough smoothly, whereby making it possible to prevent the adhesion and adsorption of the constituents of the fluid to the channel 12 without fail.

As another advantage, by virtue of its outstanding chemical stability, glass is highly resistant to chemical attack and is able to cover the channel 12 tightly, Therefore, even if the supply of the fluid is carried out under severe conditions, for example, even if the fluid has strong acidity or strong alkalinity, or much time needs to be spent in passing the fluid through the channel, it does not occur that any trace metal elements are eluted from glass that will eventually exert adverse effects upon reactions or analysis of the fluid. That is, it is possible to prevent elution of trace metal elements in ppm order, and thereby effectively avoid erroneous detection, for example, eliminate any chance of eluted metal elements being detected in the case of an inclusion of the fluid. As a result, analysis can be conducted with higher degree of accuracy.

It is particularly desirable to use quartz glass of 100 mass percent silica purity. In the case of applying a coating of quartz glass to the channel, since neither impurities nor constituents other than silica are present on the exposed channel surface, it is possible to avoid variation in contact angle resulting from difference in affinity for water among impurities and other constituents, and thereby obtain a channel of small contact angle with stability. As a result, adsorption of the fluid constituents such as protein and DNA to the channel can be prevented more reliably. Moreover, by virtue of high resistance to chemical attack of quartz glass, even if the fluid has strong acidity or strong alkalinity for example, it is possible to cover the inner surface of the channel without fail. As a result, analysis with very high degree of accuracy can be conducted.

In the case of composing the base body 11 of sintered. alumina, the coating material 52 for covering a part of the channel 12 should preferably be adjusted to be lower in melting point than sintered alumina constituting the base body 11. In this case, the application of the coating material 52 is made following the completion of sintering of alumina, and the coating material 52 is then sintered at a temperature lower than the melting point of sintered alumina to cover a part of the channel 12. Although there is a significant difference in thermal expansion between the base body 11 and the coating material 52, it is possible to apply the coating material 52 to the channel 12 with stability without causing any breakage in the coating material 52. In the meanwhile; by adjusting the melting point of the coating material 52 for covering the channel 12 to be close to the melting point of sintered alumina constituting the base body 11, it is possible to achieve the application of the coating material 52 to the channel 12 by simultaneous sintering. In this case, the channel 12 and the coating material 52 can be bonded together with high adhesion strength by an inter-diffusion effect, As a result, it is possible to produce the fluid examination chip 1 that is excellent in chemical resistance, heat resistance, and detectability and is operable under various conditions with high productivity at lower manufacturing cost. Here, when the coating material 52 is glass, the melting point of the coating material 52 means the softening point of glass.

It is preferable that the smooth surface area of the channel 12 has an arithmetic average surface roughness of 1 μm or below (according to JIS B 0601-1994).

In the case of setting the surface roughness of the smooth surface area of the channel 12 at or below 1 μm, the surface roughness of the channel 12, namely asperities on the surface can be made sufficiently small relatively to the size of a target substance contained in the fluid (such as a substrate) that may possibly be caught in the asperities. Therefore, the adhesion and adsorption of the fluid or the constituents of the fluid (blood (blood corpuscle) and DNA in particular, the analysis of which is highly demanded in the medical field) to the surface asperities of the channel 12 can be prevented successfully. In addition to that, it is possible to avoid occurrence of residual fluid within the channel 12 after the passage of the fluid, and thereby effect reactions and analysis with very high degree of accuracy.

Now, micro-chemical the experiment as described below was conducted to verify the effect obtained in the case where the surface of the channel 12 is covered with the coating material 52. Fluid examination chip samples used for evaluation were constructed as follows. At first a slurry is prepared with use of an aluminum oxide raw material at a viscosity of 2 Pa.s. The slurry is then shaped into green sheets by means of doctor blade technique. Next, a die is pressed against a surface of the green sheet under a pressure of 5 MPa to create a linear channel which is 100 μm in width, 100 μm in depth, and 5 cm in length. After that, among the green sheets, the one which is formed into a sample in which no coating is applied onto a surface of the channel thereof is fired at a temperature of approximately 1600° C. In this way, there was obtained a fluid A examination chip sample composed of a base body and a channel that are each made of ceramic.

Moreover, the green sheet which is formed into a sample in which a glass coating is applied onto a surface of the channel thereof is subjected to the following process. A paste of powdery quartz glass is applied to the linear channel formed in the green sheet by means of screen printing technique. After that, firing is performed thereon at a temperature of approximately 1600° C. so that the green sheet and the paste of powdery quartz glass may be unified through sintering. In this way, there was obtained a fluid examination chip sample with its channel surface covered with glass.

Further, the green sheet which is formed into a sample in which a hydrophilic resin coating is applied onto a surface of the channel thereof is subjected to the following process. Fluorine polymer having a hydrophilic functional group including phosphorus atoms is poured into the ceramic channel surface having undergone firing, followed by curing it at a normal temperature. In this way, there was obtained a fluid examination chip sample with its channel surface covered with resin.

Note that, regarding arithmetic average roughness, in the fluid examination chip sample which is not covered with the coating material on the channel surface thereof, having the channel formed of ceramic through firing (ceramic channel), in the presence of asperities, its arithmetic average surface roughness is greater than 1.0 μm. Therefore, the surface of the sample's base body was subjected to predetermined physical treatment to reduce the asperities until the arithmetic average surface roughness of the channel is adjusted to 1.0 μm. On the other hand, in both of the fluid examination chip sample with its channel surface covered with glass and the sample with its channel surface covered with resin, the channel has little surface asperities through the glass- or resin-coating process. Here, in order to make channel surface roughness uniform, each of the base bodies of the two samples was subjected to predetermined physical treatment to roughen its surface until the arithmetic average surface roughness of the channel is adjusted to 1.0 μm.

Herein, the arithmetic average roughness is determined on the basis of the standard according to JIS B 0601-1994 under conditions of a cutoff value of 2.5 mm and an evaluation length of 12.5 mm.

The arithmetic average roughness can be measured by means of a three dimension measurement machine which scans an object with laser light to draw an image of the object and a laser microscopy. The arithmetic average roughness can be measured from the image of the surface of the object.

The lid body which is formed by laminating a 0.25 mm-thick glass as a laminating material on a 0.25 mm-thick silicone resin, is bonded to each of the base bodies. The lid body is provided with through holes of diameter of 2 mm, each of which constitutes the supply portion and the discharge portion communicating with the channel of the base body. This through holes communicate with the capture area of 5 mm in the length and of 5 mm in the width, formed in the base body.

The silicone resin material is made of polydimethylsiloxane, the hardness and the tackiness of which are set at 6 and 5, respectively, by changing the degree of cross-linking according to the amount of application of a curing agent under certain heat-treatment conditions.

The hardness of the silicone resin material was measured by means of a hardness test apparatus (product name: Durometer Type ESC) manufactured by Elastron, Inc in accordance with the standard of the Japanese Society of Rubber Industry SRIS 0101 (based on a spring type hardness instrument Asker C model). The hardness measurement was conducted immediately after the intimate contact of the surface of the material to be pressurized. On the other hand, the tackiness thereof was measured by means of a tackiness test apparatus (product name: Tackiness tester LST-57) manufactured by Bansei corporation in accordance with Rolling Ball Tack Test (according to JIS Z 0237) at a tilting angle of 30 degrees.

Subsequently, contact angle measurement was performed on each of the samples for evaluation with use of a protein solution of a solution of protein (10 mg/mL) (A9771: manufactured by SIGMA-ALDRICH Corporation) and a TE buffer solution (the reagent specially made for molecular biological research) having a pH of 8.0. The measurement results revealed that the contact angle of the ceramic channel is 53.0°, the contact angle of the glass-coated channel is 32.3°, and the contact angle of the resin-coated channel is 12.1°. Note that contact angle measurement was conducted by means of a contact angle meter type CA-X manufactured by Kyowa Interface Science Co., Ltd. in accordance with the sessile drop method.

Next, the protein solution was supplied into the sample through the supply portion by means of a micro-syringe at a flow rate of 0.1 cm³/min. and then circulated through the channel for three minutes. After that, the TE buffer solution was circulated therethrough for one minute to carry out cleaning. Then, the detection portion, and more specifically, the bottom surface of the channel within a given area: 100 μm in length and 100 μm in width was examined through the opening under a fluorescence microscope of 100 magnifications. The results of the observation are listed in Table 2. The observed object is magnified under the fluorescence microscope until each of the openings of the supply portion and the discharge portion becomes 2 mm in diameter and the surface of the capture area becomes 5 mm in length and 5 mm in width in the lid body

In Table 2, “Good” entered in the residue section represents that a residue of protein adhered or adsorbed to the channel surface is less than 10% per observation area, whereas “Poor” represents that a residue of protein adhered or adsorbed to the channel surface is greater than 10% per observation area.

TABLE 2

| | Channel surface | | |
|---|---|---|---|
| | Ceramic | Glass | Resin |
| Residue | Poor | Good | Good |

As will be understood from Table 2, the amount of a protein residue adhered and adsorbed to the ceramic channel is high, but the amount of a protein residue adhered and adsorbed to the glass-coated channel or the resin-coated channel having a small contact angle is almost negligible.

Next, there were fabricated six base body samples of different arithmetic average roughness: 0.5 μm, 0.8 μm, 1.0 μm, 1.1 μm, 13 μm, and 2.0 μm as regards the ceramic channel, the glass-coated channel, and the resin-coated channel, respectively, by means of physical surface roughening treatment.

The lid body which is formed by laminating a 0.25 mm-thick glass as a laminating material on a 0.25 mm-thick silicone resin, is bonded to each of the base bodies. The lid body is provided with through holes of diameter of 2 mm, each of which constitutes the supply portion and the discharge portion communicating with the channel of the base body. This through holes communicate with the capture area of 5 mm in the length and of 5 mm in the width, formed in the base body.

Subsequently residue measurement was performed on each of the samples for evaluation as listed in Table 3 with use of λ-DNA solution (Code No. 3010) produced by TANAKA BIO Co., Ltd. (0.3 μg/μL) and SYBER Gold solution produced by Molecular Probes (1 μL/5000 μL). The mixture of solutions in equal proportions prepared by using a TE buffer solution was poured into the sample through the supply portion by means of a micro-syringe at a flow rate of 0.1 cm³/min. and then circulated through the channel for three minutes. After that, the TE buffer solution was circulated therethrough for one minute to carry out cleaning. Then, the detection portion, and more specifically, the bottom surface of the channel within a given area: 100 μm in length and 100 μm in width was examined through the opening under a fluorescence microscope of 100 magnifications. The results of the observation are listed in Table 2.

In Table 3, “Good” entered in the residue section represent that a residue of DNA adhered or adsorbed to the channel surface is less than 10% per observation area; “Poor” represents that a residue of DNA adhered or adsorbed to the channel surface is greater than 50% per observation area; “Not good” represents that a residue of DNA adhered or adsorbed to the channel surface falls in a range of from 10% to 50% per observation area; and “-” represents that no measurement was conducted on the ceramic channel because no further reduction of asperities was possible.

TABLE 3

| | | Ra (μm) | | | | | |
|---|---|---|---|---|---|---|---|
| | | 0.5 | 0.0 | 1.0 | 1.1 | 1.3 | 2.0 |
| Residue | Ceramic | — | — | Poor | Poor | Poor | Poor |
| | Glass | Good | Good | Good | Not | Not | Not |
| | | | | | good | good | good |
| | Resin | Good | Good | Good | Not | Not | Not |
| | | | | | good | good | good |

As will be understood from Table 3, the samples for evaluation having the glass- or resin-coated channels are free from a residue of DNA adhered and adsorbed to the channel surface so long as their arithmetic average roughness is 1 μm or below. In addition, when the arithmetic average roughness of the ceramic channel surface is 1 μm, a residue of DNA adhered and absorbed to the channel surface dominates more than 50% of the observed area. However, the residue is not captured and accumulated enough to detect DNA like the surface of the capture area 17.

Even the fluid examination chip 1 of the first embodiment provides relatively smooth surface in the area except for the area corresponding to the rough surface area, allowing a smooth flowing of the fluid. Furthermore, when the surface of the area except for the area corresponding to the rough surface area is covered with the coating material, the capture of the target substance by the surface is prevented more effectively.

It should be noted that the invention is not limited to the embodiments and examples as described hereinabove, and therefore various changes and modifications my be made without departing from the spirit and scope of the claimed invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the rang of equivalency of the claims are therefore intended to be embraced therein.

what is claimed is:

1. A fluid examination chip comprising:
a base body having a channel through which a fluid flows in at least one of a surface and an interior thereof, the channel including a capture area where a predetermined substance contained in the fluid is caught,
wherein an arithmetic average roughness on a surface in at least the part of the capture area of the channel is larger than that on a surface in the other area of the channel.

2. The fluid examination chip according to claim 1, wherein the surface in at least the part of the capture area has arithmetic average roughness over 1 μm.

3. The fluid examination chip according to claim 1, wherein the surface in the another area of the channel is coated with a material of which contact angle with the fluid is smaller than a contact angle of a material constituting the base body with the fluid.

4. The fluid examination chip according to claim 3, wherein the coated surface in the another area of the channel has an arithmetic average roughness of 1 μm or below.

5. The fluid examination chip according to claim 3, wherein the material for coating the surface in the another area of the channel is glass.

6. The fluid examination chip according to claim 3, wherein a melting point of the material for coating the another area of the channel is lower than that of the base body.

7. The fluid examination chip according to claim 1, further comprising a lid body attached onto a surface of the base body,
wherein the lid body is attached so as to cover the channel provided in the surface of the base body.

8. The fluid examination chip according to claim 7, wherein a part of the capture area of the channel which part faces the lid body has an arithmetic average roughness over 1 μm.

9. The fluid examination chip according to claim 7, wherein a part of the lid body which part faces the capture area is translucent.

10. The fluid examination chip according to claim 1, wherein the base body comprises:
a supply portion for admitting the fluid into the channel;
a treatment portion for treating the fluid in a predetermined manner, disposed partway along the channel; and
a discharge portion for discharging the fluid treated by the treatment portion out of the channel to outside,
wherein the capture area is located downstream of the treatment portion and upstream of the discharge portion along a direction in which the fluid flows.

11. A fluid detection optical system comprising:
a fluid examination chip including a base body having a channel through which a fluid flows in at least one of a surface and an interior thereof, the channel including a capture area where a predetermined substance contained in the fluid is caught, wherein an arithmetic average roughness on a surface in at least the part of the capture area of the channel is larger than that on a surface in the other area of the channel;
a irradiator which irradiates the capture area with light; and
a light receiver which receives light emitted from the predetermined substance caught in the capture area when being irradiated with the light by the irradiator.

12. The fluid detection optical system according to claim 11, further comprising an analyzer which analyzes the light received by said light receiver to measure an optical property of the predetermined substance caught in the capture area.

13. A fluid detection electrical system comprising:
a fluid examination chip including a base body having a channel through which a fluid flows in at lest one of a surface and an interior thereof, the channel including a capture area wherein a predetermined substance contained in the fluid is caught and a pair of electrodes arranged in the capture area, wherein an arithmetic average roughness on a surface in at least the part of the capture area of the channel is larger than that on a surface in the other area of the channel; and
a detector which detects the presence of the predetermined substance based on the voltage or current between the pair of electrodes.

14. A method of manufacturing a fluid examination chip, comprising:
forming a groove in at least one of a plurality of ceramic green sheets, the groove eventually serving as a channel after firing;
applying glass paste to a part of a surface of the groove, the glass paste having a softening point lower than a temperature at which the plurality of ceramic green sheet is fired;
stacking the plurality of ceramic green sheets on top of one another; and
firing the plurality of stacked ceramic green sheets.

15. A method of detecting a predetermined substance contained in a fluid, comprising:
preparing a fluid examination chip including a base body having a channel through which a fluid flows in at least one of a surface and an interior thereof, the channel including a capture area where a predetermined substance contained in the fluid is caught, wherein arithmetic average roughness on a surface in at least the part of the capture area of the channel is larger than that on a surface in the other area of the channel
irradiating the capture area with light;
receiving a fluorescence emitted from the predetermined substance when being irradiated with the light; and
analyzing the received fluorescence to detect the predetermined substance.

16. A method of detecting a predetermined substance contained in a fluid, comprising:
preparing a fluid examination chip including a base body having a channel through which a fluid flows in at least one of a surface and an interior thereof, the channel including a capture area where a predetermined substance contained in the fluid is caught and a pair of electrodes arranged in the capture area, wherein arithmetic average roughness on a surface in at least the part of the capture area of the channel is larger than that on a surface in the other area of the channel; and
detecting the predetermined substance caught in the captured area based on voltage or current between the pair of electrodes.

17. The method of detecting according to claim 16, wherein the predetermined substance is a first DNA, comprising attaching a second DNA to one of the pair of electrodes, the second DNA having complementary base sequence to the first DNA, wherein the first DNA is detected based on whether current flows between the pair of electrodes or not.
